(19) United States
(12) Patent Application Publication
(10) Pub. No.: US 2026/0112846 A1
(43) Pub. Date: Apr. 23, 2026

(54) RECEPTACLE CONNECTOR AND CONNECTOR ASSEMBLY HAVING THE SAME

(71) Applicant: P-TWO INDUSTRIES INC., Taoyuan City (TW)

(72) Inventors: Hsien-Chang LIN, Taoyuan City (TW); Chun-Wei CHANG, Taoyuan City (TW); Chih-Wei HUANG, Taoyuan City (TW)

(21) Appl. No.: 19/079,794

(22) Filed: Mar. 14, 2025

(30) Foreign Application Priority Data
Oct. 21, 2024 (TW) 113140004

(51) Int. Cl. H01R 13/6581; H01R 12/72; H01R 24/50

(52) U.S. Cl. CPC H01R 13/6581; H01R 12/722; H01R 24/50

(57) ABSTRACT

A receptacle connector and a connector assembly having the same are provided. The receptacle connector is disposed on a substrate and used to mate with a plug connector. The plug connector has multiple coaxial cables. The receptacle connector comprises a housing assembly, a plurality of contacts and a sliding cover. The housing assembly has a sliding track portion. The contacts are held by a rear end of the housing assembly, and each contact has a terminal portion extending beyond the rear end of the housing assembly. The sliding cover is disposed in the slide track portion and is configured to slide horizontally along the slide track portion. When the plug connector is inserted into the receptacle connector, the plug connector pushes the sliding cover to slide horizontally along the slide track portion so the covering portion is configured to cover the terminal portions to form an electromagnetic shielding effect.

### CROSS-REFERENCES TO RELATED APPLICATIONS

This application claims the benefit of priority to Taiwanese Patent Application No. 113140004 filed on Oct. 21, 2024, which is hereby incorporated by reference in its entirety.

### BACKGROUND OF THE INVENTION

### Field of the Invention

The present invention relates to a receptacle connector, and in particular to a receptacle connector with an electromagnetic shielding effect.

### Descriptions of the Related Art

LVDS (Low Voltage Differential Signaling) is a data transmission technology widely used in high-speed data transmission. Its main characteristic is the transmission of differential signals through two signal lines, enabling high-speed communication at a lower voltage (typically between 0.3V and 0.6V), while offering low power consumption, low noise, and strong resistance to electromagnetic interference.

The primary application scenarios for LVDS include LCD display panels, notebooks, and other contexts where LVDS is used to transmit data and control signals, as well as widespread use in high-speed communication fields such as telecommunications, automotive electronics, and industrial control. The advantages of LVDS lie in its high transmission rate (typically reaching hundreds of Mbps or higher), and because it employs differential signal transmission, it can effectively suppress noise, making it particularly suitable for application scenarios requiring high speed and low power consumption.

However, in high-speed communication environments, electromagnetic fields between adjacent signal sources can interfere with each other, leading to crosstalk, which affects the accurate transmission of data. This phenomenon is particularly pronounced in densely wired configurations or under high-speed transmission conditions. Such electromagnetic interference may cause signal distortion or attenuation, especially at the connection points between connectors and cables. Therefore, in the field of high-speed communication, there is an urgent need for an innovative connector design that effectively reduces the interference of electromagnetic effects on transmitted signals, thereby ensuring the stability and accuracy of data transmission.

### SUMMARY OF THE INVENTION

One of the objectives of the present invention is to provide a connector with an innovative sliding structure. Through the precise coordination between elements, it facilitates element assembly and automated optical inspection, while also providing the protective effect of electromagnetic shielding.

Another objective of the present invention is to provide a connector with a locking function to prevent detachment between the receptacle connector and the plug connector. Additionally, it features a compact structural design, offering the advantages of low cost, high reliability, and a thin profile.

To achieve the above objective, the present invention discloses a receptacle connector, disposed on a substrate and configured to mate with a plug connector having a plurality of coaxial cables. The receptacle connector comprises a housing assembly, a plurality of contacts and a sliding cover. The housing assembly has a sliding track portion disposed therein. The contacts are held by a rear end of the housing assembly and each contact has a terminal portion extending beyond the rear end of the housing assembly. The sliding cover is disposed in the slide track portion and configured to slide horizontally along the slide track portion. The sliding upper cover has a front edge portion and a covering portion, wherein the covering portion is disposed on a rear edge of the sliding cover relative to the front edge portion. After the plug connector is inserted into the receptacle connector, the plug connector pushes the front edge portion so the sliding cover slides horizontally along a first end of the slide track portion to a second end of the slide track portion opposite to the first end so the covering portion of the sliding cover is configured to cover each terminal portion to form an electromagnetic shielding effect.

In one embodiment of a receptacle connector of the present invention, the housing assembly further has an insulating housing, a receptacle top shell and a receptacle bottom shell. The receptacle top shell and the receptacle bottom shell jointly cover the insulating housing. The rear end of the housing assembly is an end surface of the insulating housing, and the terminal portions of the contacts extend from the end surface.

In one embodiment of a receptacle connector of the present invention, the receptacle top shell has an extended end surface extending beyond the end surface of the insulating housing. When the sliding cover slides horizontally to the second end of the slide track portion, the extended end surface is configured to cover the terminal portions together with the covering portion of the sliding cover.

In one embodiment of a receptacle connector of the present invention, the insulating housing has a lower sliding slot, and the receptacle top shell has an upper sliding slot. The upper sliding slot and the lower sliding slot together define the sliding track portion.

In one embodiment of a receptacle connector of the present invention, the sliding cover further has two extending arms, wherein each of the extending arms extends downward from a side edge of the sliding cover into the sliding track portion of the housing assembly, and each of the extending arms has a limit pin protruding outward from each of the extending arms. The extending arms are configured to be restricted by the sliding track portion of the housing assembly for sliding horizontally between the first end and the second end.

In one embodiment of a receptacle connector of the present invention, the lower sliding slot has a guiding inclined surface, used to guide the limit pin of the sliding cover along the guiding inclined surface and position the limit pin to the first end of the sliding track portion when assembling the sliding cover to the housing assembly.

In one embodiment of a receptacle connector of the present invention, the receptacle top shell has two vertical limit pieces, and the sliding cover further has two wing portions wherein each vertical limit piece is respectively disposed on either side of the receptacle top shell adjacent to each of the terminal portions. When the sliding cover slides horizontally from the first end to the second end of the sliding track portion, one of the two vertical limit pieces is configured to restrict one of the two wing portions sliding internally and horizontally for preventing the wing portion from disengaging outward.

In one embodiment of a receptacle connector of the present invention, the receptacle top shell has a stop piece, and when the sliding cover slides horizontally to the second end of the sliding track portion, the front edge portion of the sliding cover is configured to be clamped by the stop piece for preventing the sliding cover from sliding back.

In one embodiment of a receptacle connector of the present invention, the receptacle connector further comprises a rotating rod, pivoted in the housing assembly. After the plug connector pushes the sliding cover to slide horizontally to the second end and the rotating rod is rotated from a first position to a second position, the rotating rod is configured to be restricted by a latch on one side of the plug connector to form a locked state for preventing the plug connector from detaching from the receptacle connector.

In one embodiment of a receptacle connector of the present invention, the receptacle top shell has two support pieces, respectively disposed on two sides of the receptacle top shell, used to support the rotating rod in the first position to prevent the rotating rod from contacting the substrate.

In one embodiment of a receptacle connector of the present invention, the sliding track portion is disposed in the insulating housing, and the insulating housing and the receptacle top shell define a space so the sliding cover is configured to slide horizontally in the space.

In one embodiment of a receptacle connector of the present invention, the sliding cover further has two extending arms wherein each of the extending arms extends horizontally from a front edge of the sliding cover into the sliding track portion of the housing assembly. The extending arms are configured to be restricted by the sliding track portion for allowing horizontal sliding between the first end and the second end.

In one embodiment of a receptacle connector of the present invention, the insulating housing further has at least one fastener disposed on the upper surface of the insulating housing, and the sliding cover further has at least one guiding slot. The at least one guiding slot is configured to accommodate the at least one fastener. When the sliding cover slides horizontally from the first end to the second end of the sliding track portion, the at least one fastener is configured to restrict the at least one guiding slot to slide horizontally for preventing the at least one guiding slot from disengaging outward.

In one embodiment of a receptacle connector of the present invention, the at least one fastener has at least one lower positioning recess, and the at least one guiding slot has at least one lower positioning protrusion. When the sliding cover slides horizontally to the second end of the sliding track portion, the at least one lower positioning protrusion is configured to be clamped by the at least one lower positioning recess for preventing the sliding cover from sliding back.

In one embodiment of a receptacle connector of the present invention, the receptacle top shell has at least one stop piece, and the sliding cover further has at least one wing portion. The at least one stop piece is a rib protruding from the lower surface of the receptacle top shell. When the sliding cover slides horizontally from the first end to the second end of the sliding track portion, the at least one wing portion is configured to slide from one end of the at least one stop piece to the other opposite end of the at least one stop piece, and is restricted by the rib for preventing the at least one wing portion from sliding back.

In one embodiment of a receptacle connector of the present invention, the receptacle connector further comprising a rotating rod, pivoted in the housing assembly. When the plug connector pushes the sliding cover to slide horizontally to the second end, and the rotating rod is rotated from a first position to a second position, and the rotating rod is configured to be restricted by at least one first protruding portion on a side edge of the plug connector to form a locked state for preventing the plug connector from detaching from the receptacle connector.

In one embodiment of a receptacle connector of the present invention, the receptacle top shell further comprises at least one second protruding portion which is disposed on a side edge of the receptacle top shell. When the rotating rod rotates from the first position to the second position, the rotating rod is configured to be restricted by the at least one second protruding portion to form the locked state for preventing the plug connector from detaching from the receptacle connector.

To achieve the above objective, the present invention discloses a connector assembly comprises a receptacle connector and a plug connector as described in any one of abovementioned embodiments. When the plug connector is mated with the receptacle connector, one of the coaxial lines is electrically connected to one of the contacts.

After referring to the drawings and the embodiments as described in the following, those the ordinary skilled in this art can understand other objectives of the present invention, as well as the technical means and embodiments of the present invention.

### BRIEF DESCRIPTION OF THE DRAWINGS

FIG. 1 is a perspective schematic view of a connector assembly in a mated state according to an embodiment of the present invention.

FIG. 2 is a perspective schematic view of a receptacle connector and a plug connector according to an embodiment of the present invention.

FIG. 3 is a schematic view of the assembly of a receptacle connector according to an embodiment of the present invention.

FIG. 4 is an exploded schematic view of the main elements of a plug connector according to an embodiment of the present invention.

FIG. 5A is a schematic view of the mating process of a receptacle connector and a plug connector according to an embodiment of the present invention.

FIG. 5B is a schematic view of a receptacle connector and a plug connector in an unmated state according to an embodiment of the present invention.

FIG. 5C is a schematic view of a receptacle connector and a plug connector in a mated state according to an embodiment of the present invention.

FIG. 5D is a schematic view of a receptacle connector and a plug connector in a locked state after mating according to an embodiment of the present invention.

FIG. 6 is a schematic view of the main elements of a receptacle connector and a plug connector according to an embodiment of the present invention.

FIG. 7 is a partially exploded schematic view of a receptacle connector according to an embodiment of the present invention.

FIG. 8A to FIG. 8C are schematic views of a sliding cover of a receptacle connector sliding horizontally between different positions on a housing assembly according to an embodiment of the present invention.

FIG. 9 is a partially enlarged schematic view of a stop piece of a receptacle connector according to an embodiment of the present invention.

FIG. 10 is a side view of a support piece of a receptacle connector according to an embodiment of the present invention.

FIG. 11 is a schematic view of a connector assembly according to another embodiment of the present invention.

FIG. 12 is a partially exploded schematic view of a receptacle connector according to another embodiment of the present invention.

FIG. 13 is a partially exploded schematic view of a plug connector according to another embodiment of the present invention.

FIG. 14A is a schematic view of a receptacle connector and a plug connector with a sliding cover in an unclosed state according to an embodiment of the present invention.

FIG. 14B is a partially enlarged schematic view of the area encircled by the dashed line in FIG. 14A.

FIG. 14C is a cross-sectional schematic view along the AA′ line segment in FIG. 14A.

FIG. 15A is a schematic view of a receptacle connector and a plug connector with a sliding cover in a closed state according to an embodiment of the present invention.

FIG. 15B is a partially enlarged schematic view of the area encircled by the dashed line in FIG. 15A.

FIG. 15C is a cross-sectional schematic view along the BB′ line segment in FIG. 15A.

FIG. 16 is a schematic view of two matching states of a guiding slot of a sliding cover and a fastener of an insulating housing according to another embodiment of the present invention.

FIG. 17 is a schematic view of a detachment-prevention mechanism for locking a rotating rod according to another embodiment of the present invention.

### DETAILED DESCRIPTION OF THE PREFERRED EMBODIMENT

In the following description, the present invention will be explained with reference to various embodiments thereof. These embodiments of the present invention are not intended to limit the present invention to any specific environment, application or particular method for implementations described in these embodiments. Therefore, the description of these embodiments is for illustrative purposes only and is not intended to limit the present invention. It shall be appreciated that, in the following embodiments and the attached drawings, a part of elements not directly related to the present invention may be omitted from the illustration, and dimensional proportions among individual elements and the numbers of each element in the accompanying drawings are provided only for ease of understanding but not to limit the present invention.

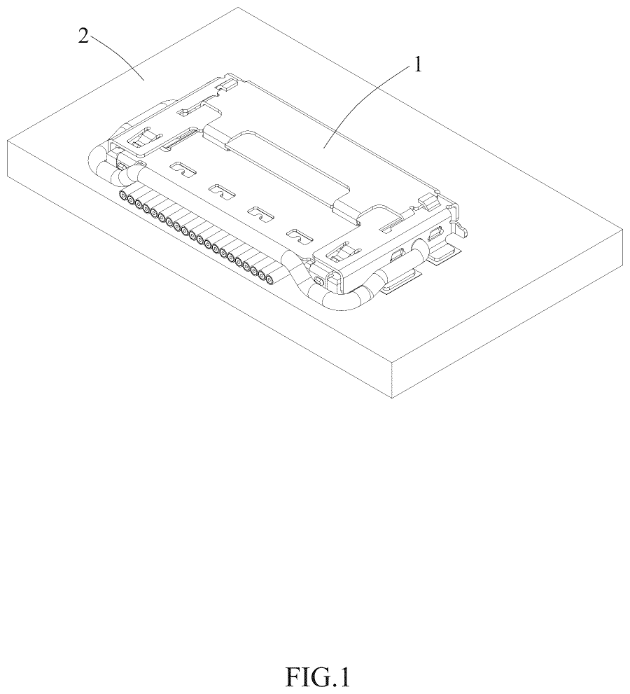

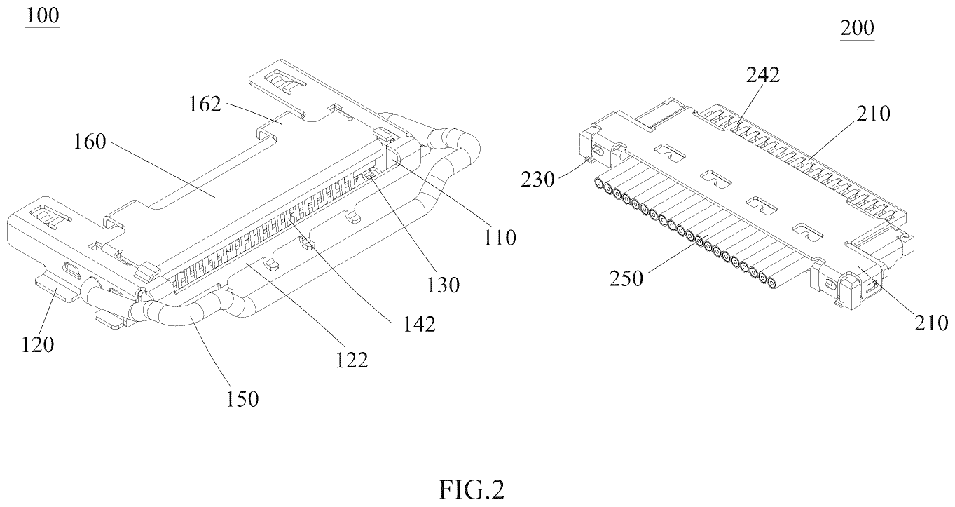

Referring to FIG. 1 and FIG. 2, an overview of the constituent elements of a connector assembly according to an embodiment of the present invention is provided. FIG. 1 is a perspective view of the connector assembly in a mated state according to an embodiment of the present invention, and FIG. 2 is a perspective view of the connector assembly in an unmated state according to an embodiment of the present invention. As shown in FIG. 1, the connector assembly 1 is disposed on a substrate 2 and includes a receptacle connector 100 and a plug connector 200 mated therewith.

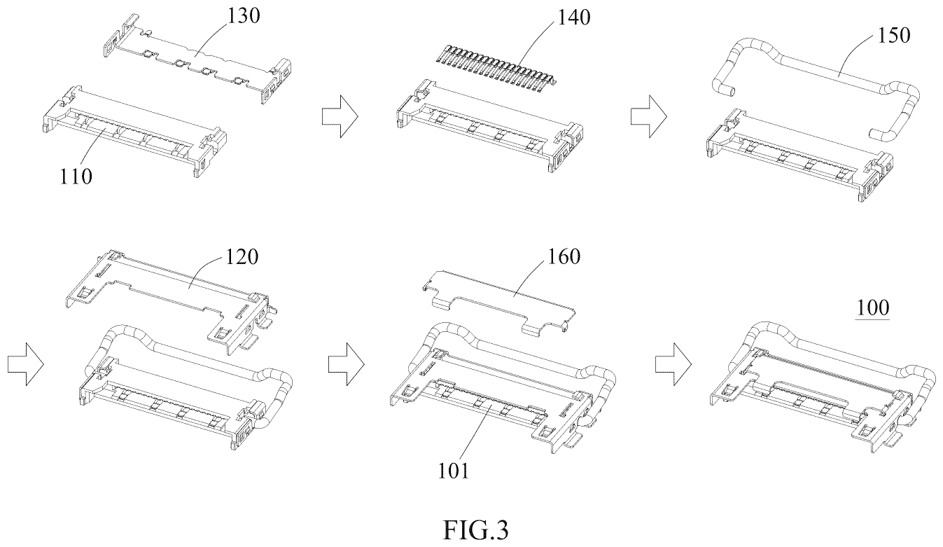

Please refer to FIG. 3, which illustrates a schematic view of the assembly of the receptacle connector 100 according to an embodiment of the present invention. The receptacle connector 100 of the present invention includes an insulating housing 110, a receptacle top shell 120, a receptacle bottom shell 130, a plurality of contacts 140, a rotating rod 150, and a sliding cover 160. After the receptacle bottom shell 130 is combined with the insulating housing 110, the contacts 140 are assembled into the insulating housing 110, with each contact 140 having a terminal portion 142 extending from an end surface of the insulating housing 110, facilitating subsequent soldering of the assembled receptacle connector 100 onto the substrate 2 for electrical connection therewith. Next, the rotating rod 150 is assembled into an accommodating groove formed collectively by the insulating housing 110 and the receptacle bottom shell 130. The receptacle top shell 120 is then placed over the insulating housing 110 and the receptacle bottom shell 130, restricting the rotating rod 150 positioned among these three elements such that the rotating rod 150 can only rotate about the accommodating groove. Additionally, the receptacle top shell 120 has an extended end surface 122 extending beyond the end surface of the insulating housing 110, configured to semi-openly cover the terminal portions 142 of the contacts 140. Clearly, as shown, the receptacle connector 100 is primarily composed of the insulating housing 110, receptacle top shell 120, and receptacle bottom shell 130, which together form a housing assembly 101. The rotating rod 150 is pivoted within the housing assembly 101 and can rotate within a certain angular range around the housing assembly. Finally, the sliding cover 160 is embedded above the housing assembly 101 and can slide horizontally relative to the housing assembly 101 over a certain distance, as detailed below.

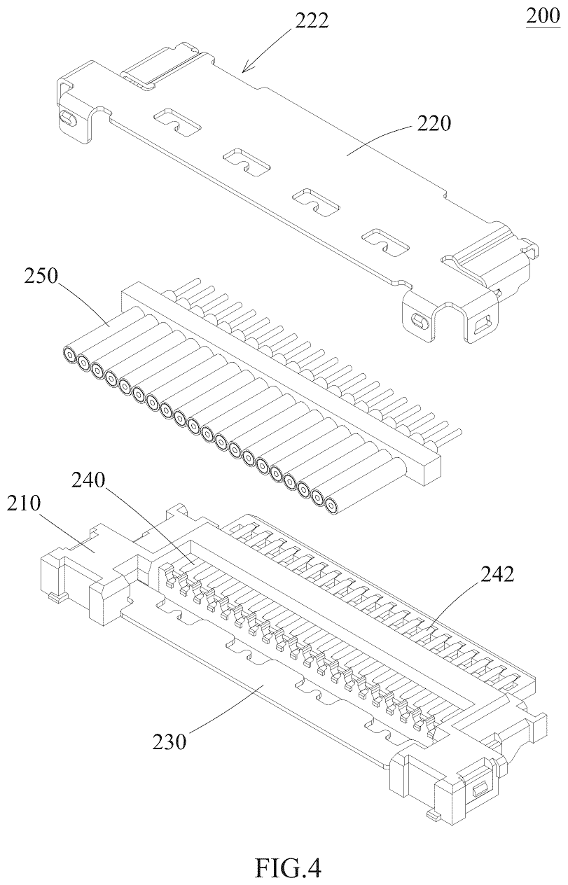

Please refer to FIG. 4, which illustrates an exploded perspective view of the main elements of the plug connector 200 according to an embodiment of the present invention. The plug connector 200 includes an insulating housing 210, a plug top shell 220, a plug bottom shell 230, a plurality of contacts 240, and a plurality of coaxial cables 250. As shown in FIG. 4, the insulating housing 210, assembled with the plurality of contacts 240 and the plug bottom shell 230 are molded together using an insert molding process. Subsequently, the plurality of coaxial cables 250, interconnected by a ground bar, are assembled into an accommodating space formed collectively by the insulating housing 210 and the plug bottom shell 230 for enabling each coaxial cable 250 to be electrically connected to a respective contact 240. Next, after a hot bar soldering process is performed to complete the grounding treatment of all coaxial cables 250, the plug top shell 220 is embedded into the insulating housing 210 and plug bottom shell 230 to finalize the assembly of the plug connector 200. It should be noted that each contact 240 of the plug connector 200 also has a terminal portion 242. Upon subsequent mating of the receptacle connector and plug connector, the terminal portions 242 of the plug connector 200 physically contact the contacts 140 of the receptacle connector 100 for enabling electrical connection therebetween for signal transmission.

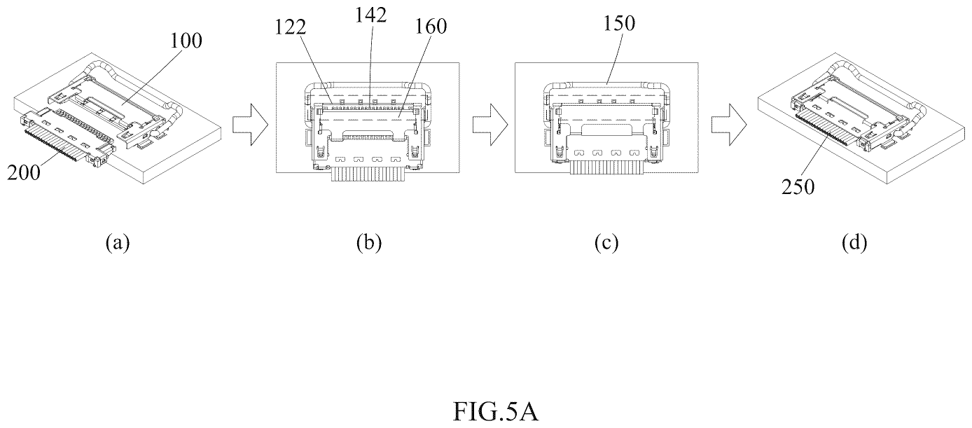

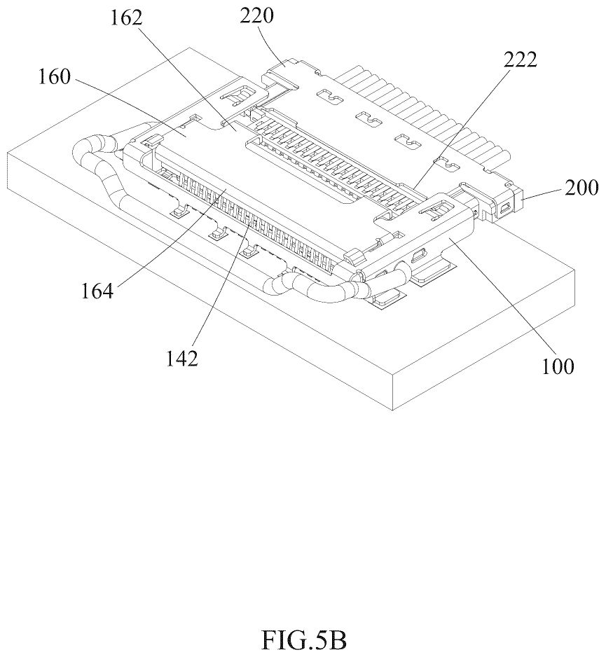

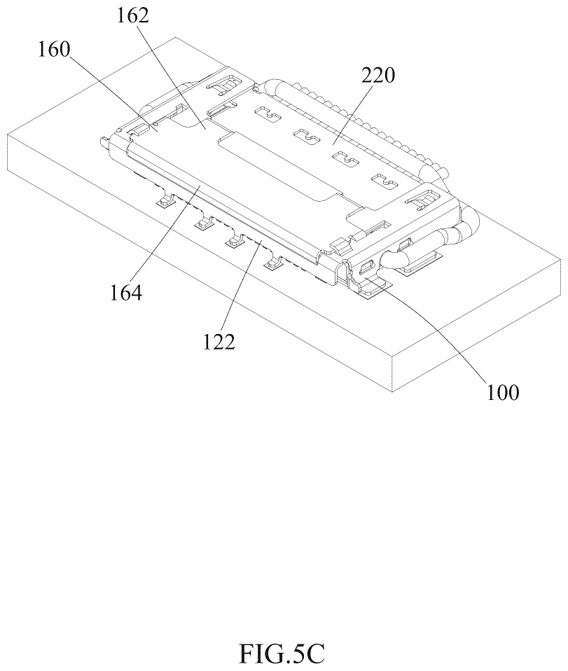

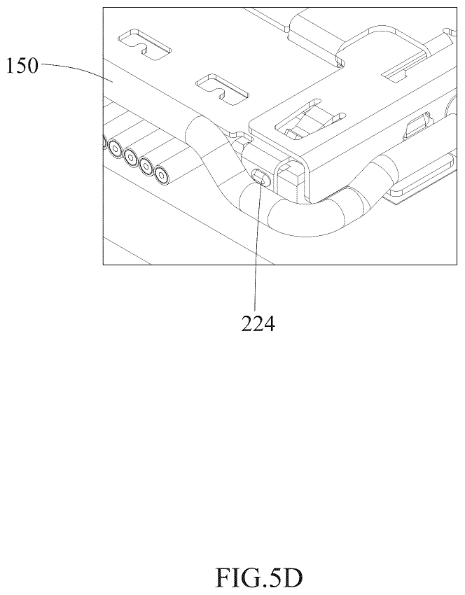

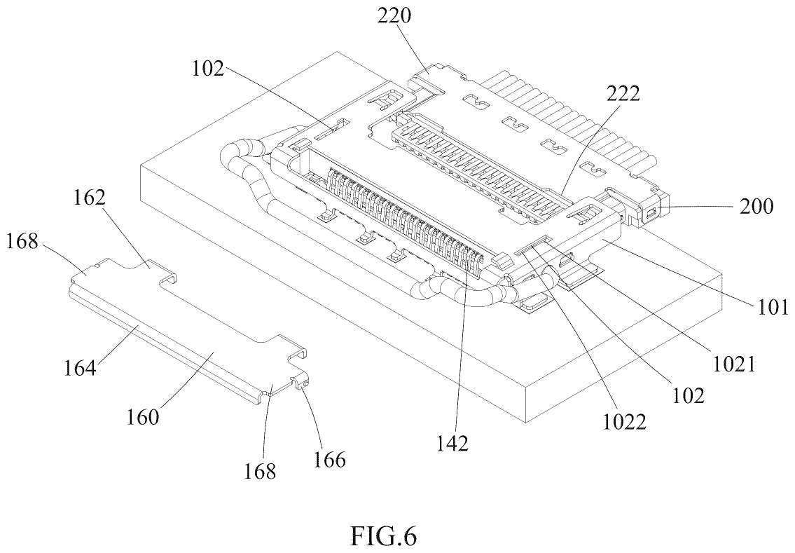

Please refer to FIG. 5A and FIG. 5B together. FIG. 5A illustrates a schematic view of the mating process between the receptacle connector 100 and the plug connector 200 according to an embodiment of the present invention, while FIG. 5B shows a schematic view of the state before mating. Specifically, the sliding cover 160 has two front edge portions 162 disposed on the front edge of the sliding cover 160, and relatively, it further has a covering portion 164 disposed on the rear edge of the sliding cover 160. In a preferred embodiment, the plug top shell 220 of the plug connector 200 has two recessed portions 222, which correspond to the two front edge portions 162 of the sliding cover 160 during the mating of the receptacle connector 100 and plug connector 200. It should be particularly noted that, before the plug connector 200 is inserted into the receptacle connector 100, the sliding cover 160 of the receptacle connector 100 is at an initial mating position relative to the housing assembly 101, as indicated by the dashed line in step (b) of FIG. 5A. At this initial mating position, the covering portion 164 of the sliding cover 160 is in an unclosed state, meaning it does not yet cover the terminal portions 142 of all contacts 140 of the receptacle connector 100. This is intended to expose the terminal portions 142 externally for facilitating visual optical inspection by automated optical inspection (AOI) equipment to verify the condition of the solder paste on the terminal portions 142. Only after the inspection confirms no issues does the mating process between the two connectors proceed.

Please continue referring to FIG. 5A and FIG. 5B. When the plug connector 200 is inserted into the receptacle connector 100, the two recessed portions 222 of the plug top shell 220 of the plug connector 200 push the two front edge portions 162 of the sliding cover 160 of the receptacle connector 100 for causing the sliding cover 160 to slide horizontally relative to the housing assembly 101 until it reaches a final mating position. At the final mating position, as indicated by the dashed line in step (c) of FIG. 5A, the covering portion 164 of the sliding cover 160 enters a closed state, fully covering the terminal portions 142 of all contacts 140 of the receptacle connector 100 in conjunction with the extended end surface 122 of the receptacle top shell 120. This forms an electromagnetic shielding effect for providing complete electromagnetic protection for signal transmission, as shown in FIG. 5C.

One feature of the connector assembly 1 of the present invention is that it includes a locking function to ensure that, once the plug connector 200 and receptacle connector 100 are fully mated, the plug connector 200 does not unexpectedly detach from the receptacle connector 100 due to changes in the usage environment. For example, traditional automotive connectors are susceptible to poor contact between connectors due to vibrations during vehicle travel. Specifically, after the plug connector 200 and receptacle connector 100 are fully mated, the rotating rod 150 on the receptacle connector 100 can be rotated from a first position near the extended end surface 122 of the receptacle top shell 120 to a second position near the coaxial cables 250 of the plug connector 200, as shown in the process from step (c) to step (d) in FIG. 5A. When the rotating rod 150 is in the second position, it is restricted by a latch 224 on a side surface of the plug top shell 220 of the plug connector 200, forming a locked state, as shown in FIG. 5D. This prevents the plug connector 200 from detaching from the receptacle connector 100 for ensuring reliable connection between the two connectors even under harsh environmental conditions and thereby guaranteeing signal transmission quality. It should be noted that, by reversing the process and rotating the rotating rod 150 from the second position back to the first position for unlocking it from the latch 224, the user can fully detach the plug connector 200 from the receptacle connector 100.

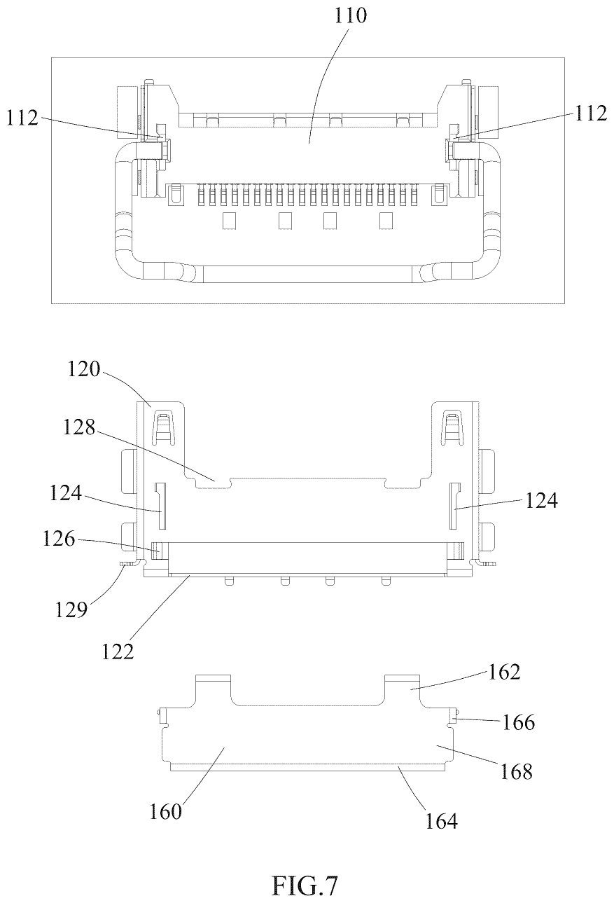

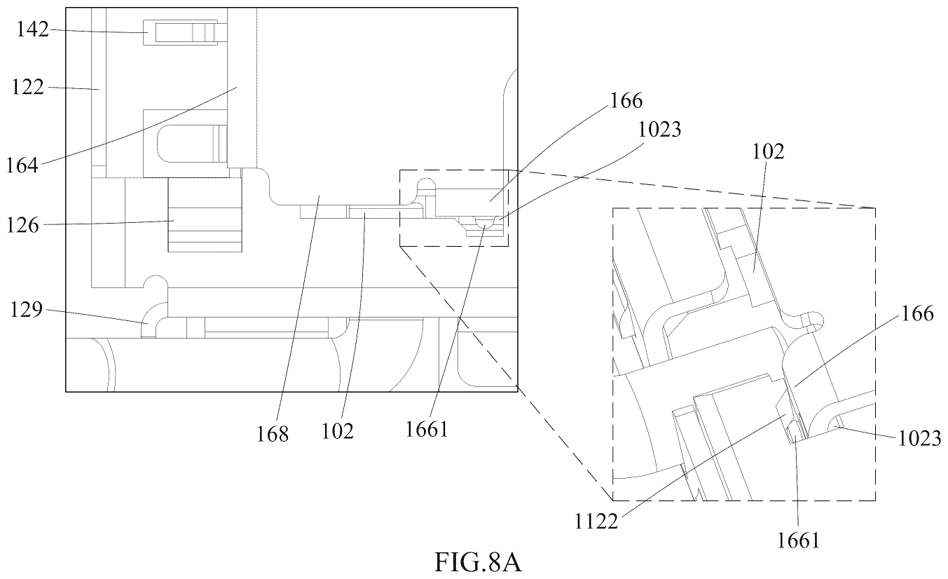

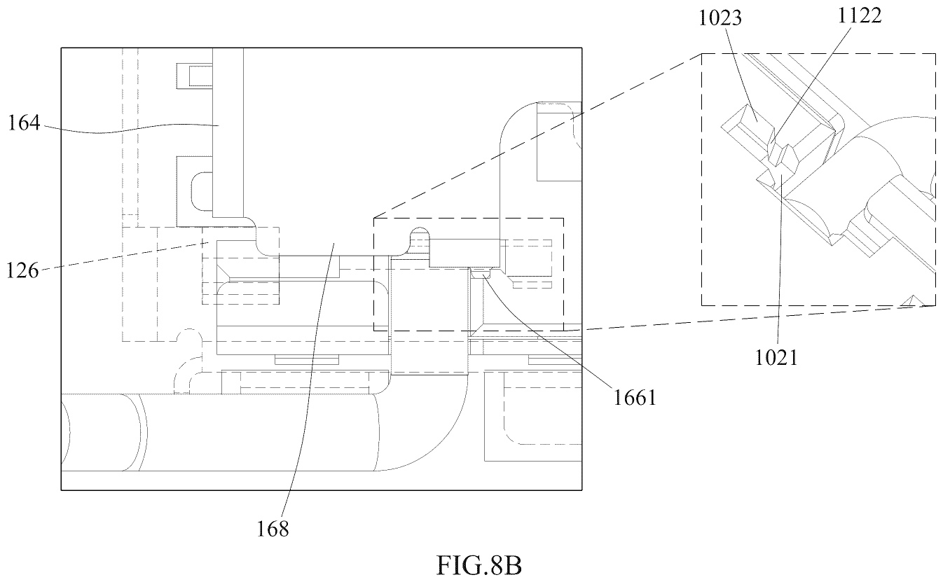

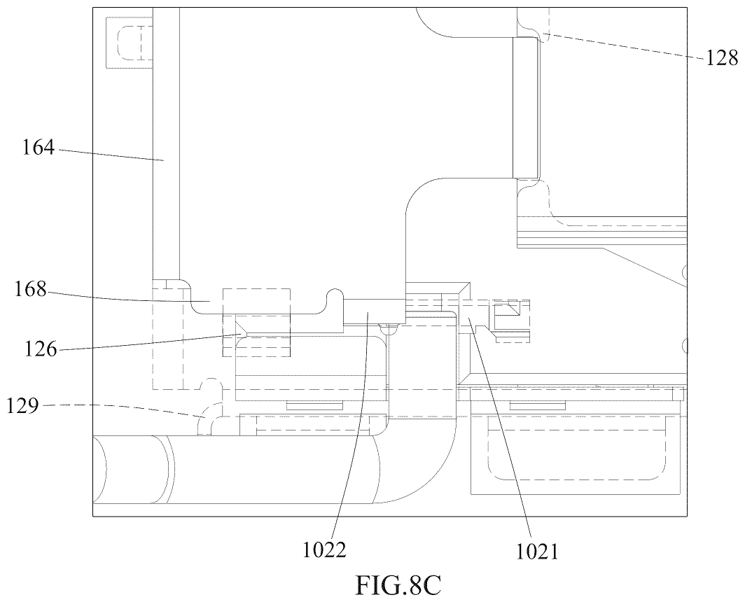

The following provides a detailed explanation of the sliding cover of the receptacle connector of the present invention, during mating with the plug connector, being pushed by the plug connector to fully cover the terminal portions of the contacts for achieving the purpose of electromagnetic shielding. Please refer to FIG. 7 and FIG. 8A to FIG. 8C together, which illustrate schematic views of the sliding cover of the receptacle connector sliding horizontally between different positions of the housing assembly. It should be noted that the housing assembly 101 of the receptacle connector 100 is provided with two sliding track portions 102, and the sliding cover 160 further has two extending arms 166 and two wing portions 168, respectively disposed at the front and rear positions of the two side edges of the sliding cover 160, as shown in FIG. 7. The sliding track portions 102 allow the sliding cover 160 to slide horizontally between two opposite ends (i.e., the first end 1021 and the second end 1022) within them. As shown in FIG. 7, it is specifically illustrated that the sliding track portion 102 of the housing assembly 101 is actually defined jointly by a lower sliding slot 112 of the insulating housing 110 and an upper sliding slot 124 of the receptacle top shell 120. Each extending arm 166 on the two sides of the sliding cover 160 extends downward from the side edge of the sliding cover 160 into the sliding track portion 102. Moreover, each extending arm 166 has a limit pin 1661 protruding outward from the extending arm 166, configured to be restricted by the sliding track portion 102 of the housing assembly 101 for allowing horizontal sliding between the first end 1021 and the second end 1022.

It should be noted that, as shown in FIG. 8A, the sliding track portion 102 is provided with an assembly slot 1023 at the front end of the first end 1021. During the initial assembly of the sliding cover 160 onto the housing assembly 101, the extending arms 166 on both sides of the sliding cover 160 can be inserted into the assembly slot 1023. Specifically, the lower sliding slot 112 of the insulating housing 110 has a guiding inclined surface 1122, as shown in FIG. 8B, configured to guide the limit pin 1661 of the sliding cover 160 along the guiding inclined surface 1122 and position it at the first end 1021 of the sliding track portion 102. As shown in the partially enlarged view in FIG. 8B (for clarity of internal structural relationships, the receptacle top shell 120 is omitted or hidden in FIG. 8B and FIG. 8C for primarily showing parts of the insulating housing 110 and the sliding cover 160), the extending arm 166 of the sliding cover 160 has a certain spatial allowance within the assembly slot 1023. During the forward movement of the extending arm 166 to the first end 1021 (as indicated by the arrow direction from FIG. 8A to FIG. 8B), the limit pin 1661 is indirectly stressed due to compression by the guiding inclined surface 1122. The assembly slot 1023 still provides a certain spatial margin for the extending arm 166 to deform appropriately without causing damage to the contacting elements. Once the extending arm 166 moves to the first end 1021, its structure returns to a normal state upon release of external force, and the structural step formed by the guiding inclined surface 1122 restricts the extending arm 166 from sliding back into the assembly slot 1023 for stably positioning the extending arm at the first end 1021.

Please continue referring to FIG. 8B and FIG. 8C, which clearly illustrate the process of the sliding cover 160 sliding from the first end 1021 to the second end 1022 of the sliding track portion 102 for enabling the sliding cover 160 to fully close the exposed terminal portions 142 of the contacts during the mating insertion of the plug connector into the receptacle connector. It should be noted that, to prevent improper vertical jumping or misalignment of the sliding cover 160 during horizontal sliding, which could result in incomplete coverage of the terminal portions 142, two vertical limit pieces 126 are provided on the receptacle top shell 120, respectively disposed on both sides of the receptacle top shell adjacent to each terminal portion 142. These vertical limit pieces 126 protrude to a certain height from the surface of the receptacle top shell 120, with a certain spatial margin between the vertical limit pieces 126 and the upper surface of the receptacle top shell 120 sufficient to accommodate the wing portions 168 on both sides of the sliding cover 160 for internal sliding. When the sliding cover 160 slides horizontally from the first end 1021 to the second end 1022 of the sliding track portion 102, the vertical limit pieces 126 on both sides of the receptacle top shell restrict the wing portions 168 on both sides of the sliding cover 160 to slide only internally for preventing them from disengaging outward. Specifically, as shown in FIG. 8A, during the initial assembly of the sliding cover 160 onto the housing assembly 101, although the extending arm 166 at one end of the sliding cover 160 is embedded in the assembly slot 1023, the wing portion 168 at the other end has not yet entered the restriction range of the vertical limit piece 126. As shown in FIG. 8B, when the extending arm 166 moves to the first end 1021, the wing portion 168 just enters the restriction range of the vertical limit piece 126. During the entire horizontal sliding travel of the sliding cover 160 from the first end 1021 to the second end 1022, as shown in FIG. 8C, the wing portions 168 on both sides of the sliding cover 160 remain fully within the restriction range of the vertical limit pieces 126 for ensuring that the sliding cover 160 does not experience unexpected jumping or misalignment during horizontal sliding. This guarantees that the terminal portions are fully covered by the covering portion 164 of the sliding cover 160 along with the extended end surface 122 of the receptacle top shell 120, free from interference by external electromagnetic noise.

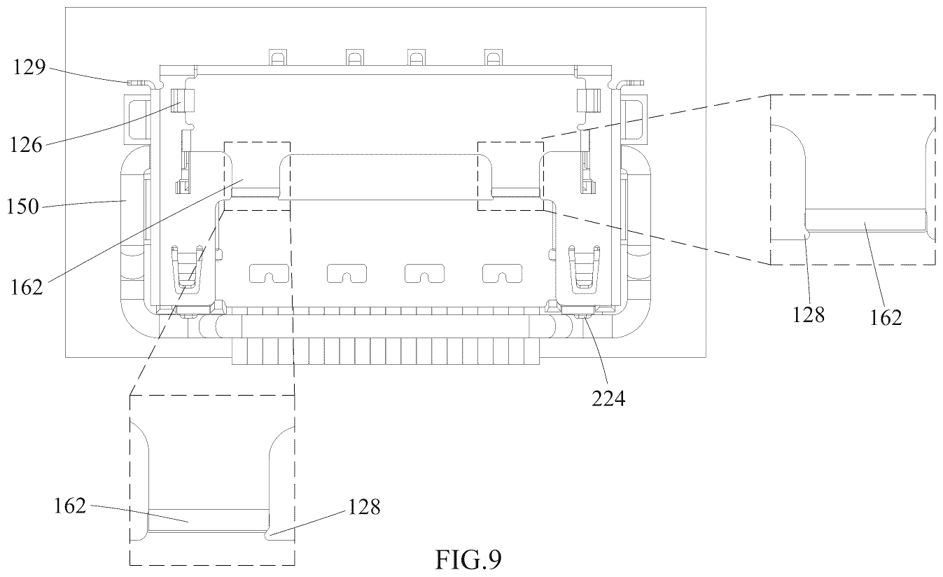

Please refer to FIG. 9, which illustrates a schematic view of a receptacle connector according to a preferred embodiment of the present invention. In this embodiment, the receptacle top shell 120 of the receptacle connector 100 further has two stop pieces 128 disposed on the upper surface of the receptacle top shell adjacent to the front edge portion 162 of the sliding cover 160. Essentially, each stop piece 128 is a protruding portion on a recessed structure (as shown in FIG. 7). The size of the recessed structure of the stop piece 128 is configured to accommodate a portion of the front edge portion 162 of the sliding cover 160, while the protruding portion forms a pouch-like recess in the recessed structure. When the sliding cover 160 slides horizontally to the second end 1022 of the sliding track portion 102, the front edge portion 162 of the sliding cover 160, pushed by the plug connector, is partially accommodated in the recessed structure of the receptacle top shell and clamped by the protruding portion of the stop piece 128 for preventing it from sliding back. This ensures that the front edge portion 162 does not detach from the receptacle top shell for further ensuring that the sliding cover 160 fully covers the terminal portions.

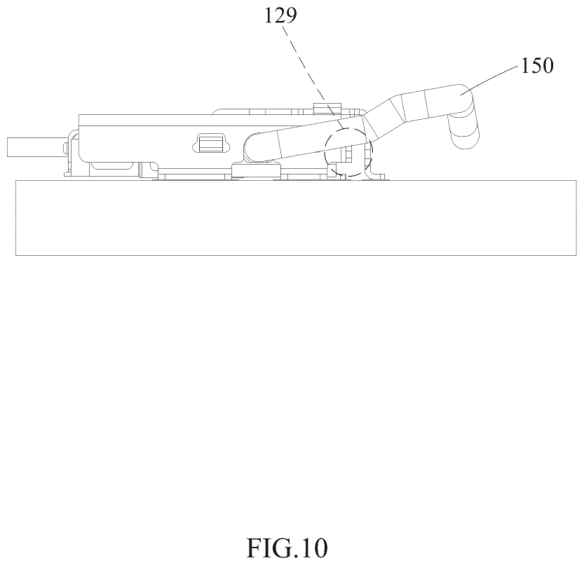

Please refer to FIG. 10. In a preferred embodiment of the present invention, the receptacle top shell 120 further includes two support pieces 129, respectively disposed on two side surfaces of the receptacle top shell 120, to support the rotating rod 150 at the first position. Specifically, when the rotating rod 150 is at the first position, it is positioned at a certain height above the substrate 2 for preventing contact with the substrate 2. When it is necessary to detach the plug connector 200 from the receptacle connector 100, the rotating rod 150 can be forced to disengage from the restriction of the latch 224 for rotating it from the second position back to the first position and allowing the connector assembly 1 to enter an unlocked state for further detachment of the plug connector 200. At this point, the rotating rod 150 rests on the support pieces 129 sufficient to prevent over-rotation that would cause it to contact the substrate 2 for thereby preventing the fixing solder points or terminals of the receptacle connector 100 being pulled away from the substrate 2 and affect the grounding integrity of the receptacle connector 100.

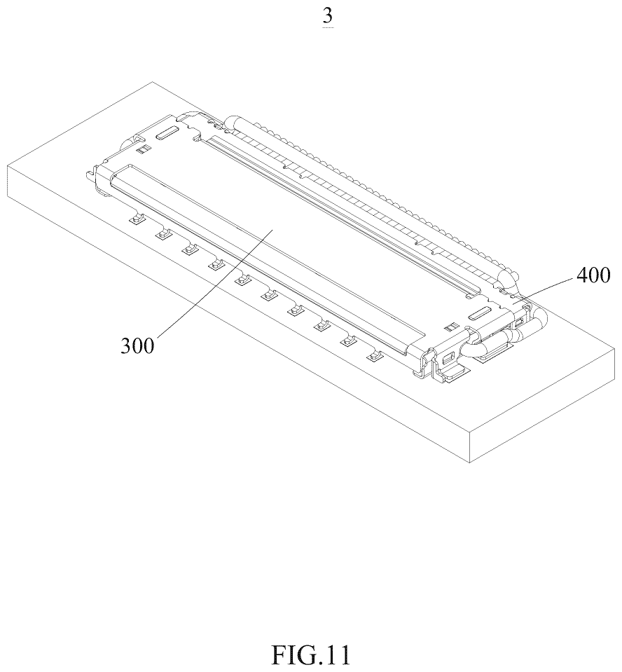

Please refer to FIG. 11 to FIG. 13 together, which respectively illustrate a schematic view of a connector assembly 3, and partially exploded schematic views of a receptacle connector 300 and a plug connector 400 according to another embodiment of the present invention. Compared to the connector assembly of the previous embodiment, the connector assembly disclosed in this embodiment achieves improved thinness and a more complete electromagnetic shielding effect. As shown, similar to the previous embodiment, the receptacle connector 300 in this embodiment primarily includes an insulating housing 310, a receptacle top shell 320, a receptacle bottom shell 330, a plurality of contacts 340, a rotating rod 350, and a sliding cover 360. The insulating housing 310, receptacle top shell 320, and receptacle bottom shell 330 together form a housing assembly 301. The contacts 340 are held by a rear end of the housing assembly 301, with each contact 340 having a terminal portion 342 extending beyond the rear end of the housing assembly 301. Unlike the previous embodiment, to achieve a thinner profile and enhanced electromagnetic shielding, the sliding cover 360 of the receptacle connector 300 in this embodiment is enclosed within the housing assembly 301. More specifically, a space (not shown) exists between the insulating housing 310 and the receptacle top shell 320 in the housing assembly 301 of this embodiment, sufficient to accommodate the sliding cover 360 and allow it to slide horizontally within this space. Compared to the previous embodiment, since the sliding cover 360 is enclosed between the insulating housing 310 and the receptacle top shell 320, the receptacle top shell 320 does not require sliding track portions for the sliding cover 360 for allowing it to have a seamless, complete structure. This provides a more comprehensive electromagnetic shielding effect. Additionally, since the sliding cover 360 slides between the insulating housing 310 and the receptacle top shell 320, there is no possibility of vertical misalignment or jumping in the thickness direction of the connector. In other words, the receptacle top shell 320 in this embodiment does not require additional vertical limit pieces as in the previous embodiment so to enable the receptacle connector to have a thinner profile with a smaller volume.

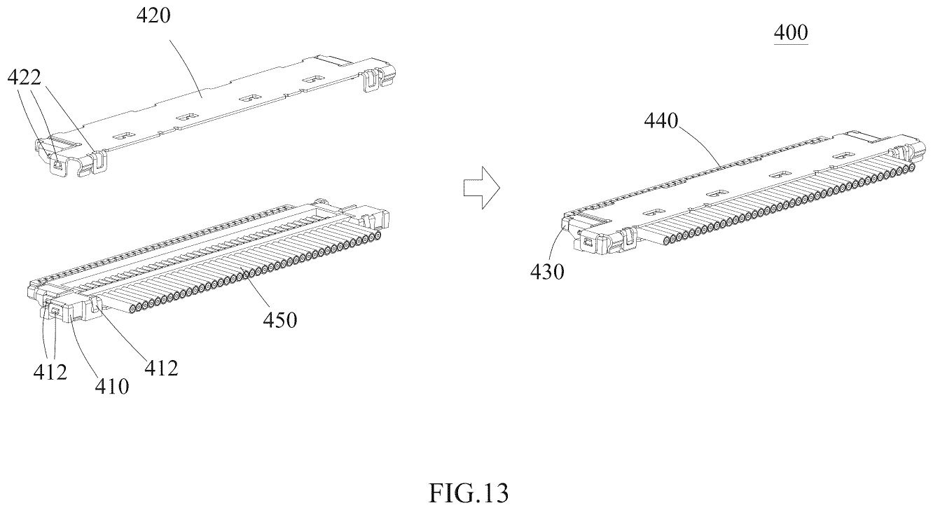

As shown in FIG. 13, similar to the previous embodiment, the plug connector 400 in this embodiment consists of an insulating housing 410, a plug top shell 420, a plug bottom shell 430, contacts 440, and coaxial cables 450. Relevant descriptions can refer to the content above and are not repeated here. It is noted that, in this embodiment, several fasteners 412 are disposed on the side surface of the insulating housing 410, and correspondingly, several openings 422 are provided at corresponding positions on the side surface of the plug top shell 420. When assembling the plug connector 400, these fasteners 412 are configured to fit tightly into the respective openings 422 for enabling a secure engagement between the plug top shell 420 and the insulating housing 410 and enhancing the structural integrity between elements.

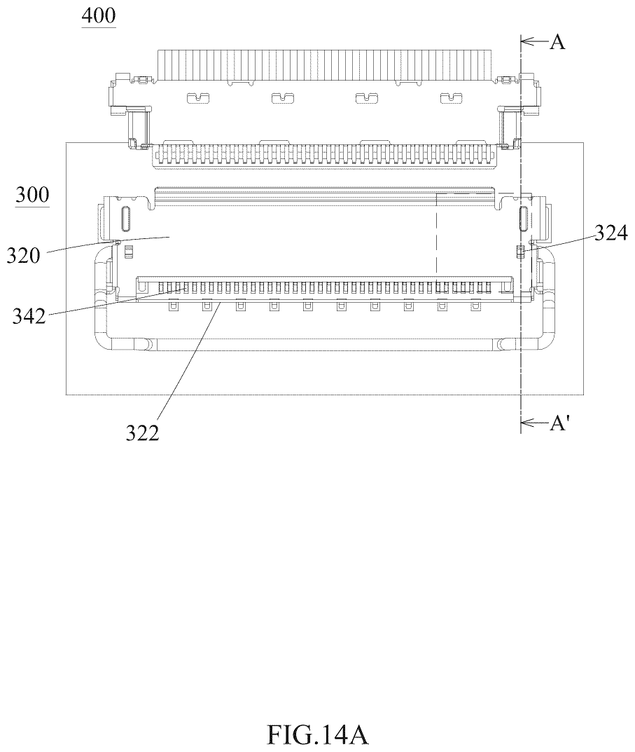

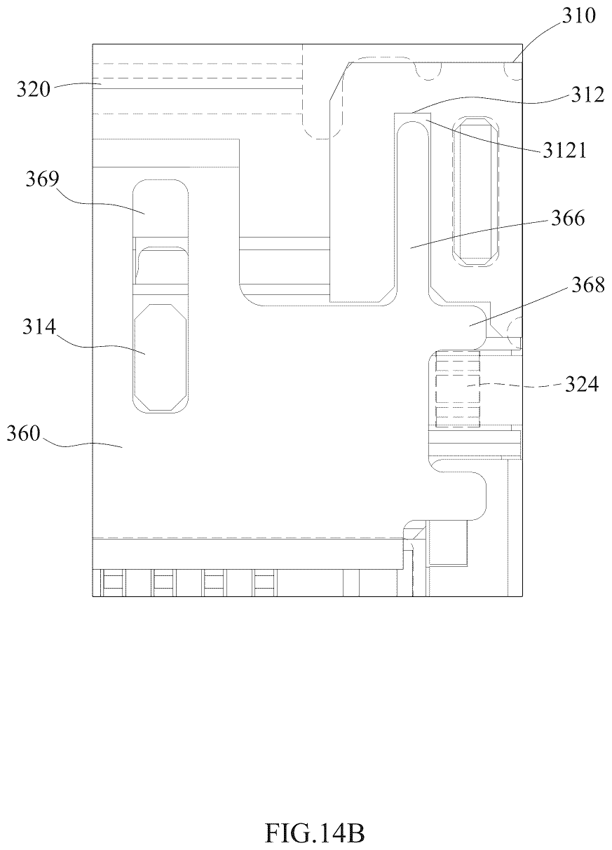

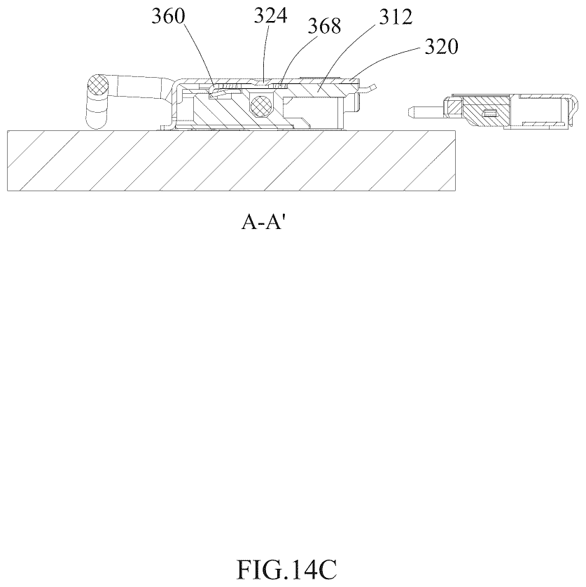

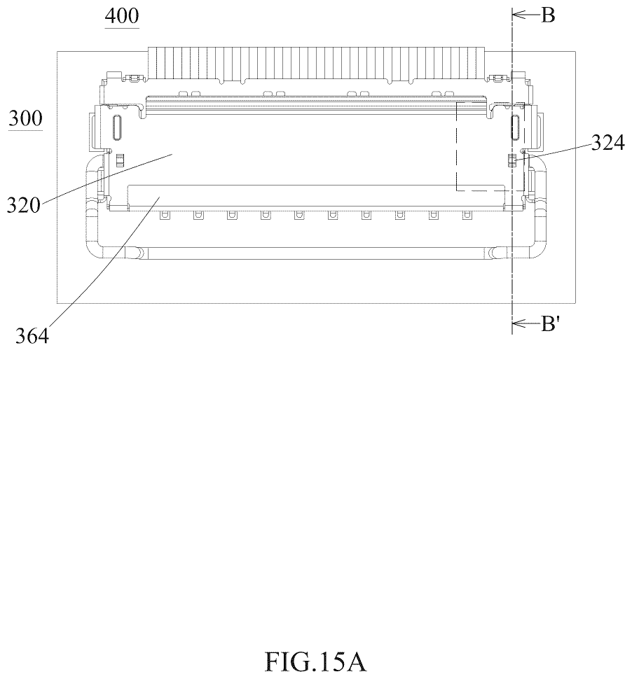

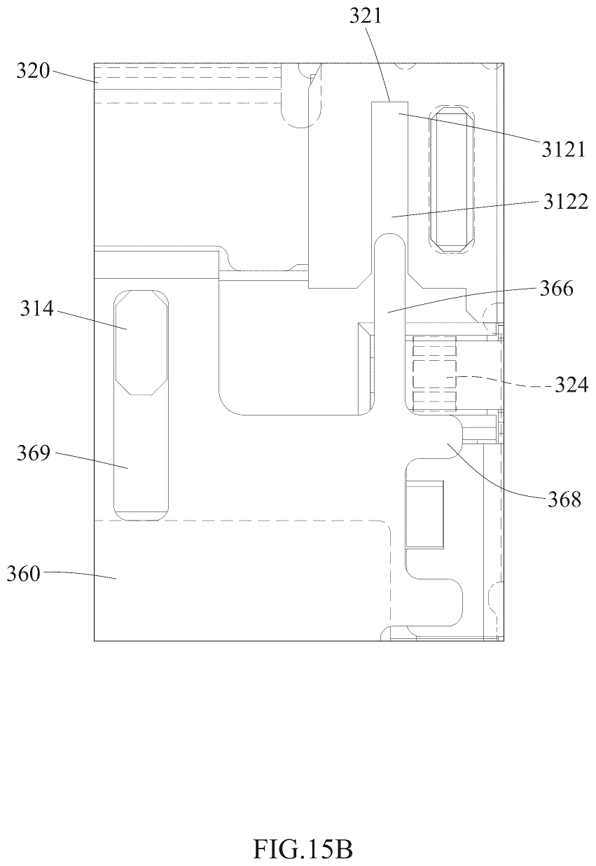

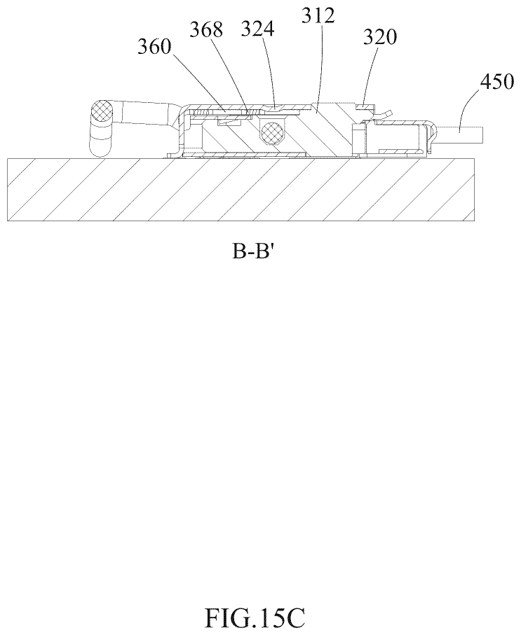

To further illustrate the operating mechanism between the sliding cover and other elements in this embodiment, please refer to FIG. 14A to FIG. 14C and FIG. 15A to FIG. 15C together, which detail the interaction between the sliding cover 360 and the insulating housing 310 in this embodiment. As shown in FIG. 14A, this illustrates the receptacle connector 300 and plug connector 400 in a state before mating, where the sliding cover beneath the receptacle top shell 320 is in an unclosed state, exposing the terminal portions 342 externally to facilitate inspection by automated optical inspection equipment. On the other hand, FIG. 14B shows a partially enlarged schematic view of the area indicated by the dashed line in FIG. 14A. Specifically, in FIG. 14B, the receptacle top shell 320 is represented with dashed lines to clearly show the interaction between the sliding cover 360 and the insulating housing 310. Additionally, FIG. 14C is a cross-sectional schematic view along the AA′ line segment shown in FIG. 14A.

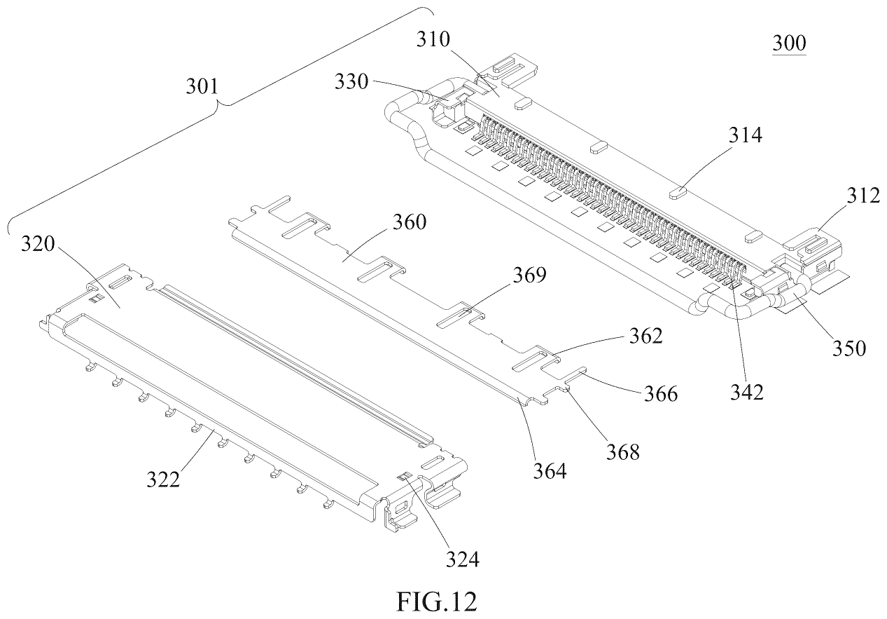

Please refer to FIG. 12 and FIG. 14B together. In this embodiment, the insulating housing 310 of the housing assembly 301 has two sliding track portions 312 disposed at two opposite side ends of the receptacle top shell 320. The receptacle top shell 320 has an extended end surface 322 and two stop pieces 324, where the stop pieces 324 are ribs protruding from the lower surface of the receptacle top shell. The sliding cover 360 includes a plurality of front edge portions 362, a covering portion 364, two extending arms 366, and two wing portions 368. The functions of the front edge portions 362 and covering portion 364, as well as their structural relationships with other elements, are similar to those in the previous embodiment and are not repeated here. Specifically, unlike the previous embodiment, the two extending arms 366 are disposed at the front edge of the sliding cover 360. When assembling the sliding cover 360 to the insulating housing 310, the extending arms 366 are configured to extend horizontally and be accommodated within the sliding track portions 312 of the insulating housing 310, as shown in FIG. 12 and FIG. 14B. On the other hand, the two wing portions 368 are respectively disposed on the two side edges of the sliding cover 360, and when assembling the sliding cover 360 to the insulating housing 310, the wing portions 368 are configured to abut the sidewalls of the sliding track portions 312. Specifically, after the receptacle top shell 320 and insulating housing 310 are assembled, the wing portions 368 are also precisely positioned on one side of the stop pieces 324 of the receptacle top shell 320, as shown in FIG. 14C.

Please refer to FIG. 12 and FIG. 15A to FIG. 15C together. FIG. 15A illustrates the receptacle connector 300 and plug connector 400 in a fully mated state in this embodiment, where the sliding cover 360 beneath the receptacle top shell 320 is in a closed state, and the covering portion 364 of the sliding cover 360, together with the extended end surface 322 of the receptacle top shell, jointly covers the terminal portions. Moreover, as compared to the previous embodiment, since the receptacle top shell 320 in this embodiment does not have sliding track portions and thus has fewer openings, the connector assembly of this embodiment can provide a more complete electromagnetic shielding effect. On the other hand, FIG. 15B shows a partially enlarged schematic view of the area indicated by the dashed line in FIG. 15A, and FIG. 15C is a cross-sectional schematic view along the BB′ line segment shown in FIG. 15A.

When the receptacle connector 300 and plug connector 400 begin mating, the sliding cover 360, pushed by the plug connector 400, enables the extending arms 366 to slide horizontally from the first end 3121 to the second end 3122 of the sliding track portion 312. As shown in FIG. 15B, it is specifically illustrated that when the extending arm 366 slides to the second end 3122, the wing portion 368 overcomes the restriction of the rib of the stop piece 324 and slides to the opposite end of the stop piece 324. After the receptacle connector 300 and plug connector 400 complete mating and the sliding cover 360 is no longer under force, the wing portion 368 is restricted by the rib of the stop piece 324 for preventing it from sliding back, as shown in FIG. 15C.

In this embodiment, to enhance the vertical stability of the sliding cover 360 during horizontal sliding and prevent misalignment or jumping, at least one fastener 314 is disposed on the upper surface of the insulating housing 310. Correspondingly, at least one guiding slot 369 is provided on the sliding cover 360 at a position corresponding to the fastener 314 and is configured to accommodate the fastener 314, as shown in FIG. 12. When the extending arm 366 of the sliding cover 360 slides horizontally from the first end 3121 to the second end 3122 of the sliding track portion 312, the fastener 314 restricts the guiding slot 369 to slide horizontally without disengaging outward for enhancing the vertical stability of the sliding cover during horizontal sliding, as shown in FIG. 14B and FIG. 15B.

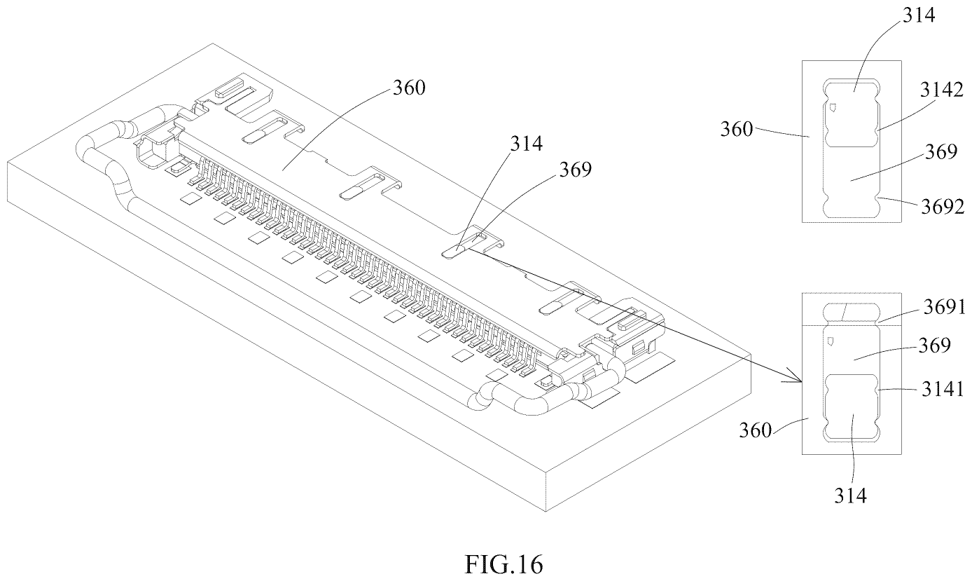

More specifically, in a preferred embodiment, as shown in FIG. 16, an upper positioning recess 3141 and a lower positioning recess 3142 are provided at the upper and lower ends of the two side edges of the fastener 314, and correspondingly, an upper positioning protrusion 3691 and a lower positioning protrusion 3692 are provided at the upper and lower ends of the two side edges of the guiding slot 369. When the sliding cover 360 begins sliding horizontally from the first end 3121 of the sliding track portion 312, the lower positioning protrusion 3692 in the guiding slot 369 of the sliding cover 360 disengages from the restriction of the lower positioning recess 3142 on each fastener 314 of the insulating housing 310 for allowing the sliding cover 360 to start sliding horizontally toward the second end 3122. When the sliding cover 360 slides horizontally to the second end 3122 of the sliding track portion 312, the upper positioning protrusion 3691 in the guiding slot 369 of the sliding cover 360 is clamped by the upper positioning recess 3141 on the fastener 314 of the insulating housing 310 for preventing the sliding cover 360 from sliding back.

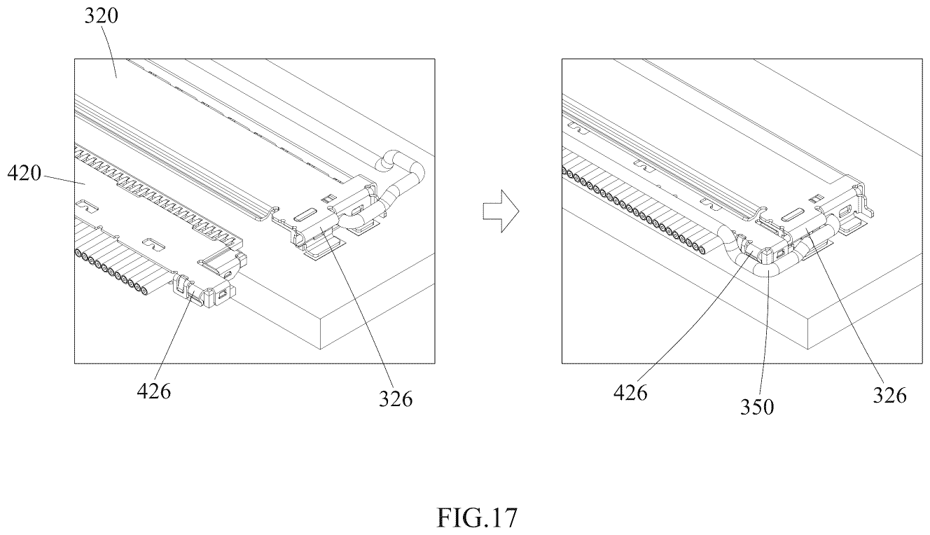

In this embodiment, to enhance the reliability of the mating between the receptacle connector 300 and the plug connector 400 of the connector assembly 3 during use and prevent the risk of detachment, please refer to FIG. 17. Protruding portions are provided on both the receptacle connector 300 and the plug connector 400 to restrict the rotation of the rotating rod for thereby preventing the plug connector 400 from detaching from the receptacle connector 300. As shown in FIG. 17, the receptacle connector 300 has a protruding portion 326 disposed on a side edge of the receptacle top shell 320, while the plug connector 400 has a protruding portion 426 disposed on a side edge of the plug top shell 420. When the rotating rod 350 rotates from a first position to a second position, the rotating rod 350 is restricted by the protruding portion 426 on the side edge of the plug connector 400 and the protruding portion 326 on the side edge of the receptacle connector 300 for forming a locked state that prevents the plug connector from detaching from the receptacle connector.

In summary, the connector assembly of the present invention features an innovative combination of a receptacle connector and a plug connector. Specifically, the receptacle connector includes a sliding cover that not only facilitates automated optical inspection to verify the solder condition on the contacts of the receptacle connector before mating with the plug connector but also, upon completion of inspection, leverages the mating process between the receptacle connector and plug connector to fully cover the connector assembly and achieve an electromagnetic shielding effect. Furthermore, the connector assembly of the present invention includes locking and unlocking functions to prevent detachment between the receptacle connector and plug connector for enhancing operational and structural reliability while offering advantages such as compact spatial design and low cost.

The above embodiments are used only to illustrate the implementations of the present invention and to explain the technical features of the present invention, and are not used to limit the scope of the present invention. Any modifications or equivalent arrangements that can be easily accomplished by people skilled in the art are considered to fall within the scope of the present invention, and the scope of the present invention should be limited by the claims of the patent application.

What is claimed is:

1. A receptacle connector, disposed on a substrate and configured to mate with a plug connector having a plurality of coaxial cables, comprising:
a housing assembly, having a sliding track portion, wherein the sliding track portion is disposed therein;
a plurality of contacts, held by a rear end of the housing assembly, wherein each of the contacts has a terminal portion extending beyond the rear end of the housing assembly; and
a sliding cover, disposed in the slide track portion of the housing assembly and configured to slide horizontally along the slide track portion, wherein the sliding upper cover has a front edge portion and a covering portion, the front edge portion is disposed on a front edge of the sliding cover, and the covering portion is disposed on a rear edge of the sliding cover relative to the front edge portion,
wherein after the plug connector is inserted into the receptacle connector, the plug connector pushes the front edge portion so the sliding cover slides horizontally along a first end of the slide track portion to a second end of the slide track portion opposite to the first end so the covering portion of the sliding cover is configured to cover each of the terminal portions of the contacts to form an electromagnetic shielding effect.

2. The receptacle connector of claim 1, wherein the housing assembly further has an insulating housing, a receptacle top shell and a receptacle bottom shell, the receptacle top shell and the receptacle bottom shell jointly cover the insulating housing, the rear end of the housing assembly is an end surface of the insulating housing, and the terminal portions of the contacts extend from the end surface.

3. The receptacle connector of claim 2, wherein the receptacle top shell has an extended end surface extending beyond the end surface of the insulating housing, when the sliding cover slides horizontally to the second end of the slide track portion, the extended end surface is configured to cover the terminal portions together with the covering portion of the sliding cover.

4. The receptacle connector of claim 2, wherein the insulating housing has a lower sliding slot, and the receptacle top shell has an upper sliding slot, the upper sliding slot and the lower sliding slot together define the sliding track portion.

5. The receptacle connector of claim 4, wherein the sliding cover further has two extending arms, wherein each of the extending arms extends downward from a side edge of the sliding cover into the sliding track portion of the housing assembly, and each of the extending arms has a limit pin protruding outward from each of the extending arms, configured to be restricted by the sliding track portion of the housing assembly for sliding horizontally between the first end and the second end.

6. The receptacle connector of claim 5, wherein the lower sliding slot has a guiding inclined surface, used to guide the limit pin of the sliding cover along the guiding inclined surface and position the limit pin to the first end of the sliding track portion when assembling the sliding cover to the housing assembly.

7. The receptacle connector of claim 2, wherein the receptacle top shell has two vertical limit pieces, and the sliding cover further has two wing portions, each of the vertical limit pieces is respectively disposed on either side of the receptacle top shell adjacent to each of the terminal portions, when the sliding cover slides horizontally from the first end to the second end of the sliding track portion, one of the two vertical limit pieces is configured to restrict one of the two wing portions sliding internally and horizontally for preventing the wing portion from disengaging outward.

8. The receptacle connector of claim 2, wherein the receptacle top shell has a stop piece, and when the sliding cover slides horizontally to the second end of the sliding track portion, the front edge portion of the sliding cover is configured to be clamped by the stop piece for preventing the sliding cover from sliding back.

9. The receptacle connector of claim 2, further comprises a rotating rod, pivoted in the housing assembly, after the plug connector pushes the sliding cover to slide horizontally to the second end, and the rotating rod is rotated from a first position to a second position, the rotating rod is configured to be restricted by a latch on one side of the plug connector to form a locked state for preventing the plug connector from detaching from the receptacle connector.

10. The receptacle connector of claim 9, wherein the receptacle top shell has two support pieces, respectively disposed on two sides of the receptacle top shell, used to support the rotating rod in the first position to prevent the rotating rod from contacting the substrate.

11. The receptacle connector of claim 2, wherein the sliding track portion is disposed in the insulating housing, and the insulating housing and the receptacle top shell define a space so the sliding cover is configured to slide horizontally in the space.

12. The receptacle connector of claim 11, wherein the sliding cover further has two extending arms, wherein each of the extending arms extends horizontally from a front edge of the sliding cover into the sliding track portion of the housing assembly, configured to be restricted by the sliding track portion for allowing horizontal sliding between the first end and the second end.

13. The receptacle connector of claim 11, wherein the insulating housing further has at least one fastener disposed on the upper surface of the insulating housing, and the sliding cover further has at least one guiding slot, the at least one guiding slot is configured to accommodate the at least one fastener, when the sliding cover slides horizontally from the first end to the second end of the sliding track portion, the at least one fastener is configured to restrict the at least one guiding slot to slide horizontally for preventing the at least one guiding slot from disengaging outward.

14. The receptacle connector of claim 13, wherein the at least one fastener has at least one lower positioning recess, and the at least one guiding slot has at least one lower positioning protrusion, when the sliding cover slides horizontally to the second end of the sliding track portion, the at least one lower positioning protrusion is configured to be clamped by the at least one lower positioning recess for preventing the sliding cover from sliding back.

15. The receptacle connector of claim 11, wherein the receptacle top shell has at least one stop piece, and the sliding cover further has at least one wing portion, the at least one stop piece is a rib protruding from the lower surface of the receptacle top shell, when the sliding cover slides horizontally from the first end to the second end of the sliding track portion, the at least one wing portion is configured to slide from one end of the at least one stop piece to the other opposite end of the at least one stop piece, and is restricted by the rib for preventing the at least one wing portion from sliding back.

16. The receptacle connector of claim 11, further comprising a rotating rod, pivoted in the housing assembly, when the plug connector pushes the sliding cover to slide horizontally to the second end, and the rotating rod is rotated from a first position to a second position, the rotating rod is configured to be restricted by at least one first protruding portion on a side edge of the plug connector to form a locked state for preventing the plug connector from detaching from the receptacle connector.

17. The receptacle connector of claim 16, wherein the receptacle top shell further comprises at least one second protruding portion, disposed on a side edge of the receptacle top shell, when the rotating rod rotates from the first position to the second position, the rotating rod is configured to be restricted by the at least one second protruding portion to form the locked state for preventing the plug connector from detaching from the receptacle connector.

18. A connector assembly comprises a plug connector and a receptacle connector as described in claim 1, wherein when the plug connector is mated with the receptacle connector, one of the coaxial lines is electrically connected to one of the contacts.
